(19) United States
(12) Patent Application Publication
(10) Pub. No.: US 2014/0304195 A1
(43) Pub. Date: Oct. 9, 2014

(54) Funding of Research & Development projects by selling financial interests in potential intellectual property rights of projects

(71) Applicant: Prateek SINGH, Chennai (IN)

(72) Inventor: Prateek Kumar Singh, Chennai (IN)

(21) Appl. No.: 14/356,518

(22) PCT Filed: Nov. 12, 2012
(86) PCT No.: PCT/IN2012/000747

§ 371 Date: May 15, 2014

Related U.S. Application Data
(60) Provisional application No. 61/559,047, filed on Nov. 11, 2011.

(51) Int. Cl. G06Q 40/06

(52) U.S. Cl. CPC G06Q 40/06
USPC 705/36 R

(57) ABSTRACT

A method of funding of Research and Development projects which allows financial market investors to invest in R&D projects. The method addresses the two existing problems of: (i) Lack of financial information with regards to R&D projects, and (ii) High risk of investments in R&D projects, faced by the financial market investors. The method comprises of doing a financial valuation of intellectual properties expected to result from the research projects, creating financial instruments representing ownership of financial interest in intellectual properties (thereby giving the choice to the investors to make investment as per their risk profile and reduce the perceived risk), pricing these financial instruments, producing financial information necessary for an investor to make investment in these instruments and offering the instruments for sale along with the financial information. Funds generated from sale of these instruments are then used for carrying out the R&D project further.

### TECHNICAL FIELD

The present invention related to a method of funding Research and Development projects.

### BACKGROUND ART

The traditional method of funding of Research and Development projects are:
1. Grants by government/non government institutions/individuals.
2. Industry.

Typically, R&D projects are projects with high risk (because of uncertainty in the results of a research) and with high investment requirement. Hence, they are funded by entities which have the capacity to bear the high risk involved in R&D funding and make the large amount of investment required viz., government, some non-government institutions, few individuals and industry. While the first three entities mentioned fund the R&D projects as grants because of their mandate to fund research or to fund research in specific field(s), the industry funds R&D projects to commercialize the projects and obtain return on investment.

### DISCLOSURE

### Technical Problem

Because of (i) High risk involved in R&D projects and (ii) Difficulty to ascertain the financial risk and return of R&D projects without being familiar with the field of R&D, the source of funds for R&D projects is limited. Many projects which can create very high impact if successful are not able to progress because of lack of funds.

Financial market investors, which constitute a large pool of funds, are not able to invest in R&D sector because of the points mentioned above. If this source of funding is made available to the R&D sector, a large number of R&D projects shall start making progress and create high positive impact once successful.

### Technical Solution

The present invention will address the two problems mentioned above and thereby open up financial market investments to R&D sector thus increasing the pool of funds available to the R&D sector.

The present invention is a method of funding of R&D projects. The method comprises of the following steps: (i) Doing valuation of the intellectual property/technology/know-how expected to be generated by the research project. (ii) Estimating cost of the research project. (iii) Based on the cost of the project and the valuation of the expected intellectual property/technology/know-how of the project, determine the fraction of expected Intellectual Property Right (IPR) which if sold would furnish the funds needed for the project. (iv) Based on the cost of project and purchasing power of investors estimate the number of parts in which the fraction mentioned in step iii should be divided such that each part would represent a share of ownership of financial interest in the IPR expected to result from the project (Let the number of parts be N and the share of ownership be S%) (v) Create N legal contracts representing S% ownership of financial interest in the IPR expected to result from the project. (These legal contracts may also represent certain specific Intellectual Property Rights such as right to license the resulting IP) (vi) Price these legal contracts based on the cost of the R&D project and the value of each of these N legal contracts as calculated from the valuation done in step i. These legal contracts will henceforth be called as financial instruments or instruments. (vii) Compile the financial information necessary for an investor to make purchasing decision regarding these financial instruments. The financial information would comprise of risk and expected return from investment in the project apart from other information. (viii) Sell these financial instruments to investors, disclosing them the price and financial information necessary for them to make purchasing decision. (ix) From whole or part of the fund thus obtained, furnish funding to the R&D project.

The invention mentioned above gives investors a choice to invest in the R&D project as per their risk appetite. Thus it reduces the perceived risk of investing in R&D projects. Second, it also gives the investors financial information which helps them make investment decision for the R&D project without having to know the technical details of R&D project, an opportunity which they were hitherto barred from. Thus, by addressing these two problems the invention will open up financial market investment for R&D sector.

In one embodiment of the invention, the financial instruments mentioned above corresponding to different (more than one) research projects can be bundled together in a particular ration (e.g., 1 instrument of Research A+2 instruments of Research B) to form new instruments. These new instruments will be similar to mutual funds. The price and investor relevant financial information for these new instruments will be determined separately. These new instruments will help the investors diversify their portfolio and thus decrease the risk further.

In one embodiment of the invention, a website can be used to disseminate information regarding the research project and the financial instruments corresponding to these research projects to investors. Investors can buy these financial instruments online via the website. The website will save information of the investors and the financial instruments owned by them. The website will have the functionality to debit the bank account of the buyer and credit the bank account meant to store the funds for R&D project as per the transaction.

In one embodiment of the invention, after pricing of the financial instrument, the investors can negotiate with the researcher/research team carrying out the research project the price for these instruments, share of ownership of financial interests represented by the instruments and intellectual property rights represented by the instruments.

In one embodiment of the invention, the above mentioned negotiation between the investors and the researcher can happen on the website which is used to sell the instruments to the investors.

In one embodiment of the invention, financial instruments (legal contracts) can contain an information disclosure agreement allowing the investor to get the information about the progress of research project at certain time intervals. Based on this information, the investor can decide to sell the financial instrument if he is not satisfied with the progress of the research. The investor can sell the financial instruments if there are other investors who are interested in buying the instrument.

In one embodiment of the invention, the website which is used to sell these instruments initially can also be used for exchange of information between researchers and investors as per the information disclosure agreement. It can also be used for selling of instruments by investors to other investors in case an investor decides to sell his instrument(s). Potential investors can register to the website, log in and then buy instruments from other investors. As a part of this transaction, the website will debit money from the bank account of buyer and credit money to the bank account of the seller. The website will update the ownership details of the transacted instruments.

With regards to the step i of the invention, i.e., the valuation step, the best mode conceived is to get Memorandum of Understanding(s) (MoUs) for commercialization of potential IPRs of the research projects signed with companies/businesses which can commercialize the IPRs. The MoUs can state commercialization as being contingent to predefined improvements in measurable parameters (e.g., 5% decrease in cost of process A, 4% increase in net profit or 10% increase in gross sales). This means the company which has signed the MoU will not commercialize the IP unless cost of process A is decreased by 5% or more, net profit to company A is increased by 4% or more or gross sales is increased by 10% or more. The royalty (or other forms of income) payments to owners of financial interest in the IPRs being commercialized can be based on these measurable parameters (e.g., 50% of cost savings of process will be passed on as royalty to IPR owners of the Intellectual Property). The MoUs can specify a jurisdiction where legal proceedings will happen in case a difference in opinion arises later on whether the invention should be commercialized. The MoUs can also specify a person or organization agreed by both the parties for resolution of a difference in opinion on commercialization. The valuation of potential IPRs can then be done based on these MoUs for commercialization. Once a research project is successful and commercialization happens, the owners of financial instruments start receiving their share of revenues. This receiving of revenues by the owners of financial instruments can happen via the website used for selling of instruments.

### Advantageous Effect

Advantageous effect of the described invention over the prior art is to: (i) Open a financial market as a new source of funding for R&D sector by giving financial information corresponding to R&D projects to financial markets. (ii) Giving a choice to financial market investors to invest as per their risk appetite thus decreasing the perceived risk of investment in R&D projects.

### Best Mode

As mentioned earlier, the best mode for carrying out the valuation step (step i) of the invention is to enter into MoUs for commercialization of the expected IPs of the research project and then do the valuation based on these MoUs.

The best mode to carry out the invention as a whole would be the best mode of the valuation step in combination with using the website for all the functionalities for which “one embodiment of the invention” in the above description is described to be carried on the website.

1. A process for funding Research and Development projects, the process comprising:
Doing valuation of the intellectual property/technology/know-how expected to be generated by the research project;
Estimating cost of the research project;
Based on the cost of the project and the valuation of the expected intellectual property/technology/ know-how of the project, determining the fraction of expected Intellectual Property Right (IPR) which if sold would furnish the funds needed for the project;
Based on the cost of project and purchasing power of investors estimating the number of parts in which the fraction mentioned in step iii should be divided such that each part would represent a share of ownership of financial interest in the IPR expected to result from the project (Let the number of parts be N and the share of ownership be S%);
Creating N legal contracts representing S% ownership of financial interest in the IPR expected to result from the project. (These legal contracts may also represent certain specific Intellectual Property Rights such as right to license the resulting IP);
Pricing these legal contracts based on the cost of the R&D project and the value of each of these N legal contracts as calculated from the valuation done in step i. These legal contracts will henceforth be called as financial instruments or instruments;
Compiling the financial information necessary for an investor to make purchasing decision regarding these financial instruments. The financial information would comprise of risk and expected return from investment in the project apart from other information;
Selling these financial instruments to investors, disclosing them the price and financial information necessary for them to make purchasing decision;
From whole or part of the fund thus obtained, furnishing funds to the R&D project.

2. The process of claim 1, wherein financial instruments also represent certain specific IPRs such as right to license the IP.

3. The process of claim 1, wherein after the step of creation and pricing of financial instruments, two or more of these financial instruments derived from different research projects can be bundled in a particular ratio to form a single instrument similar to a mutual fund, this single instrument is priced and then the following steps as in claim 1 are performed.

4. The process of claim 1, further comprising the step of negotiation between investors and researcher/research team for the price of these instruments, share of ownership of financial interests represented by the instruments and intellectual property rights represented by the instruments.

5. The process of claim 1, wherein the instruments also contain an information disclosure agreement, which results in further (after the investors are in possession of the instruments) comprising the steps of information disclosure between the investors and the researcher/research team.

6. The process of claim 5, further comprising the step of investor(s) offering the instrument for sale.

7. The process of claim 6, further comprising the step of other investor(s) buying the instrument(s) offered for sale.

8. The process of claim 1, wherein the step of valuation of intellectual property comprises of the steps of:
Signing MoUs for commercialization with companies which can commercialize the IP;
Valuing the IP based on these MoUs.

9. The process of claim 8, wherein the MoU for commercialization is contingent to certain predefined improvements in measurable parameters (e.g., 5% decrease in cost of process A, 4% increase in net profit)

10. The process of claim 8, wherein any difference in opinion regarding commercialization after generation of IP can be resolved under the jurisdiction as agreed in the MoU.

11. The process of claim 8, wherein any difference in opinion regarding commercialization after generation of IP can be resolved under the jurisdiction as agreed in the MoU.

12. The process of claim 8, wherein any difference in opinion regarding commercialization after generation of IP can be resolved by a person or organization agreed by both the parties in the MoU.

13. The financial instrument product representing shares of financial interest in intellectual property expected to be generated from the research project.

14. The financial instrument product of step 13, further comprising of specific intellectual property rights like licensing rights.

15. An application software hosted on a web server comprising a computer readable program code as means for:
Storing details of financial instruments;
Disseminating information about financial instruments which is necessary for investors to make purchasing decision;
Registering the investors and storing identification information of investors;
Allowing purchase of instruments by investors;
Crediting and debiting appropriate bank accounts on purchase of instrument(s) by investors;
Storing information about ownership of instrument(s) by investors.

16. The application software of claim 15, further comprising computer readable code means for negotiation between investors and researcher.

17. The application software of claim 15, further comprising of computer readable code means for disclosure of information by researcher/research team and viewing of the disclosed information by investors.

18. The application software of claim 15, further comprising of computer readable code means for allowing the investors to offer the instrument(s) they own for sale.

19. The application software of claim 15, further comprising of computer readable code means for allowing the investors to buy instrument(s) offered for sale.
